(19) United States
(12) Patent Application Publication
(10) Pub. No.: US 2007/0246577 A1
(43) Pub. Date: Oct. 25, 2007

(54) CONVERGING SPRAY SHOWERHEAD

(76) Inventor: Leland C. Leber, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/738,291

(22) Filed: Apr. 20, 2007

Related U.S. Application Data
(60) Provisional application No. 60/745,261, filed on Apr. 20, 2006.

(51) Int. Cl. B05B 1/14; A62C 31/02; A62C 2/08

(52) U.S. Cl. 239/589; 239/548; 239/558

(57) ABSTRACT

Showerheads with two or more nozzles configured to deliver water streams that converge at one or more regions. Prior to convergence, the converging water streams may generally retain a recognizable shape determined by the type of nozzle. Upon convergence, at least portions of the converging water streams may substantially disperse into multiple individual water droplets. The nozzles, or a face plate or other components joining the nozzles to a showerhead, may be selectively movable to selectively move the region or regions of convergence closer to or further away from the showerhead, or to convert the nozzles from delivering converging streams to delivering non-converging streams or vice versa. Some showerheads may further include other nozzles for delivering water from the showerhead in other modes, such a high pressure mode, a pulsating mode, a mist mode, and so on.

### CROSS-REFERENCE TO RELATED APPLICATIONS

This application claims the benefit under 35 U.S.C. § 119(e) of U.S. Provisional Application No. 60/745,261, entitled “Converging Spray Showerhead” and filed on Apr. 20, 2006, which is hereby incorporated by reference herein in its entirety.

### BACKGROUND OF THE INVENTION

a. Field of the Invention

The present invention generally relates to showerheads.

b. Background Art

Standard showerheads typically provide spray patterns of generally parallel or diverging round water streams, hollow water cones, fan shaped water streams, or fine mist sprays. These spray patterns are generally adequate to supply water for a shower. However, it may be desirable to have a showerhead that reduces the amount of water needed to provide adequate water coverage during a shower and/or to improve the spray pattern's feel or visual appeal. Accordingly, what is needed in the art is an improved showerhead.

### BRIEF SUMMARY OF THE INVENTION

The present invention includes showerhead systems for causing water streams or sprays delivered from a showerhead to at least partially break into multiple, random water drops prior to contacting a user. The showerhead system may include a showerhead with two or more nozzles configured to cause water streams or sprays to converge at one or more regions in space, and/or one or more nozzles that deliver a rotating water stream or spray with a sufficient angular velocity to break the stream or spray into multiple droplets. The showerhead system may include a showerhead and one or more structures operatively associated with the showerhead that cause one or more water streams or sprays to break into multiple droplets upon impact with the structure.

One embodiment of a showerhead may take the form of a water inlet and a plurality of nozzles. The plurality of nozzles may be in fluid communication with the water inlet. At least two of the plurality of nozzles may be configured such that water streams exiting the at least two of the plurality of nozzles converge at least at one region to substantially convert at least portions of the water streams into multiple water droplets. The showerhead may further include a body defining at least one flow path for fluidly joining the water inlet to at least one of the plurality of nozzles. At least one of the at least one region may be selectively movable relative to the showerhead.

### BRIEF DESCRIPTION OF THE DRAWINGS

FIG. 1A is a front perspective view of a first example of a showerhead with converging streams shown schematically.

FIG. 1B is another front perspective view of the showerhead depicted in FIG. 1 with the converging streams shown representatively.

FIG. 2 is a perspective view of a second example of a showerhead showing a first shower pipe connection structure.

FIG. 3 is another perspective view of the showerhead depicted in FIG. 2.

FIG. 4A is a cross-sectional view of the showerhead depicted in FIG. 2, viewed along line 4A-4A in FIG. 2.

FIG. 4B is a detailed view of a showerhead nozzle for the showerhead depicted in FIG. 2.

FIG. 5A is a perspective view of another second example of a showerhead showing another shower pipe connection structure.

FIG. 5B is an exploded perspective view of the showerhead depicted in FIG. 5A.

FIG. 6 is a perspective view of a third example of a showerhead.

FIG. 7 is a bottom view of the showerhead depicted in FIG. 6.

FIG. 8 is a schematic top view of the showerhead depicted in FIG. 6.

FIG. 9A is a perspective view of a fourth example of a showerhead, showing the showerhead operating in a first mode of operation.

FIG. 9B is a perspective view of the showerhead depicted in FIG. 9A, showing the showerhead operating in a second mode of operation.

FIG. 10 depicts a rear perspective view of the showerhead depicted in FIG. 9A with the cover removed to show the fluid chambers contained within the showerhead body, which may be fluidly connected to the nozzles.

FIG. 11 is a perspective view of a fifth example of a showerhead

FIG. 12A is a partial cross-sectional view of the showerhead depicted in FIG. 11, viewed along line 12A-12A in FIG. 11 and showing the nozzles in a first position.

FIG. 12B is a partial cross-section view similar to the view shown in FIG. 12A, showing the nozzles after moving the nozzles to a second position.

FIG. 12C is a partial cross-section view similar to the view shown in FIG. 12A, showing the nozzles after moving the nozzles to a third position.

FIG. 13A is a exploded view of the showerhead depicted in FIG. 11.

FIG. 13B is another exploded view of the showerhead depicted in FIG. 11.

FIG. 14 is a perspective view of a sixth example of a showerhead.

FIG. 15 is a bottom view of the showerhead depicted in FIG. 14.

FIG. 16 is a partial exploded view of the showerhead depicted in FIG. 14, showing the flexible showerhead face plate and the adjustment mechanism for moving the showerhead plate from a planar to a curved profile, and vice versa.

FIG. 17 is a partial cross-sectional view of the showerhead depicted in FIG. 14, viewed along line 17-17 in FIG. 15 and showing the flexible face plate in a substantially planar position.

FIG. 18 is cross-section view similar to the view shown in FIG. 12A, showing the flexible plate in a outward convex position.

### DETAILED DESCRIPTION OF THE INVENTION

Described herein are showerhead systems for causing water streams or sprays delivered from a showerhead to at least partially break into multiple, random water drops prior to contacting a user. In some embodiments, the showerhead system may take the form of a showerhead with two or more nozzles configured to deliver water streams or sprays (which may be referred to as streams and/or sprays hereinafter) that converge at one or more regions. Prior to convergence, the converging water streams may generally retain a recognizable shape determined by the type of nozzle. Upon convergence, at least a portion of the converging water streams may substantially disperse into multiple individual water droplets. The resultant water droplets may provide a more uniform distribution of water than individual streams or cones of water as supplied by conventional showerheads, which may result in the use of less water than a conventional showerhead to achieve a similar water coverage and/or wet feel. Further, the resultant water droplet distribution may have a pleasing feel similar to the feel of rain droplets from a sudden heavy rain such as a cloud burst and/or an aesthetically pleasing visual spray pattern.

In some embodiments, the showerhead system may take the form of a showerhead including one or more nozzles that deliver a rotating water stream or spray with a sufficient angular velocity to break the stream or spray into multiple droplets. In some embodiments, the showerhead system may include a showerhead and one or more structures operatively associated with the showerhead that cause one or more water streams or sprays to break into multiple droplets upon impact with the structure. Any of the various embodiments, may incorporate features of other embodiments to provide multiple approaches in a showerhead system to at least partially break water streams or sprays delivered from the showerhead system into multiple, random water drops.

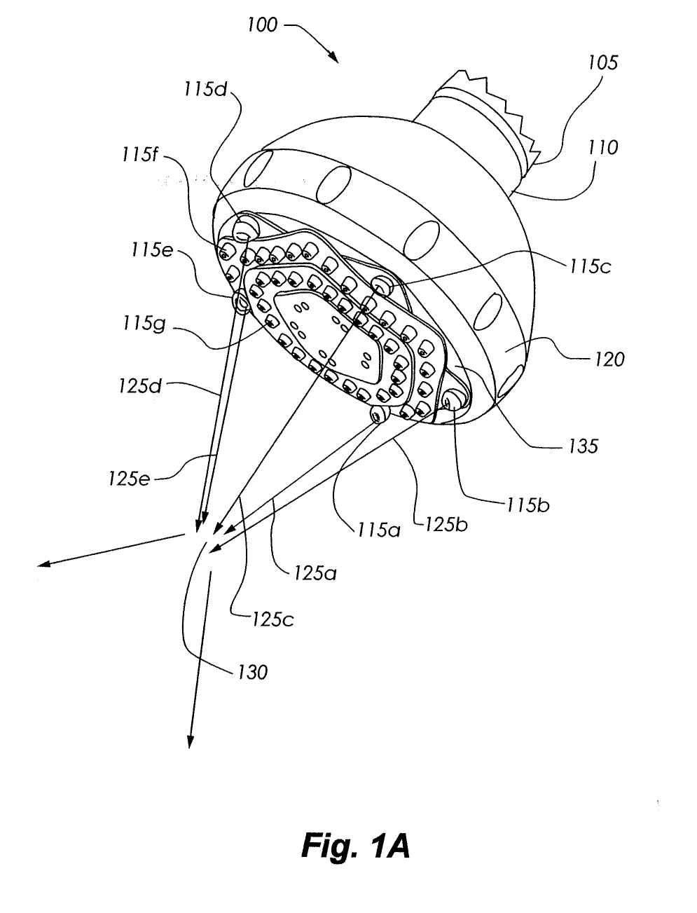

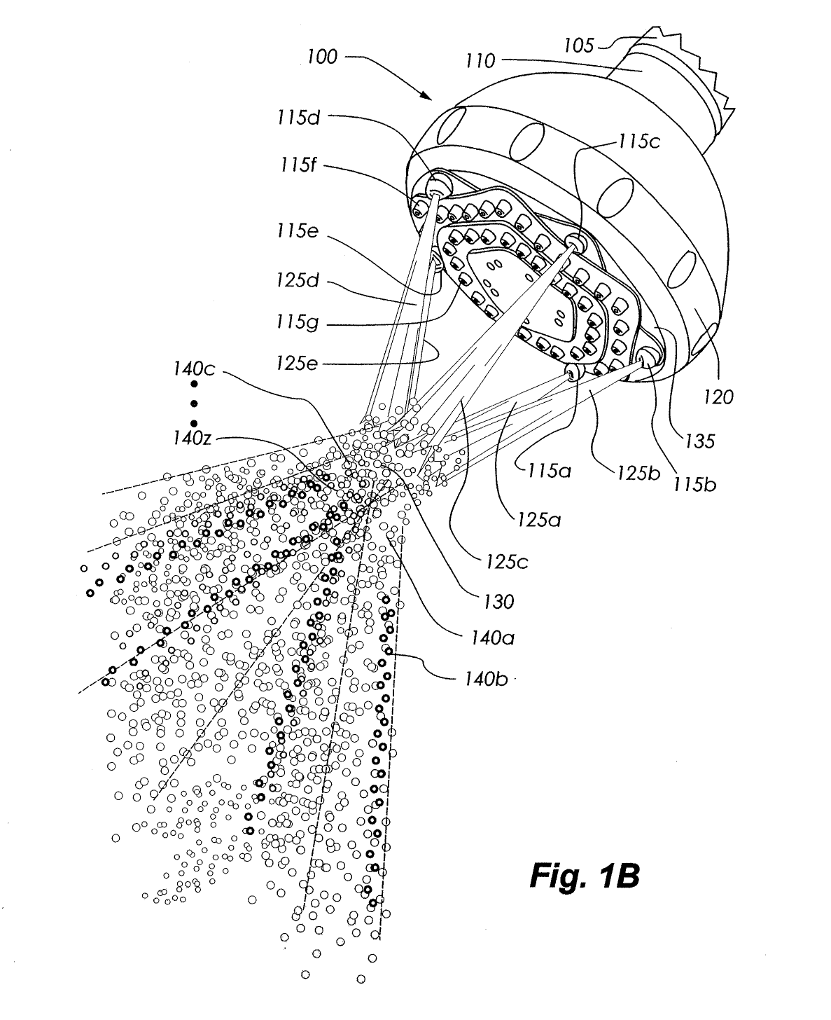

FIGS. 1A and 1B depict a first example of a showerhead 100 with converging sprays. The showerhead 100 may have a water inlet for receiving water from a shower pipe 105 or other water source and a connection portion 110 for attaching the showerhead 100 to the shower pipe 105 (either directly or indirectly). The showerhead 100 may include one or more flow paths (not shown) for directing water received from the shower pipe 105 (or other water source) to one or more showerhead nozzles 115a-g. Each flow path may be selectively opened or closed using a rotating ring 120 or other selection device to allow or prevent water flow to one or more showerhead nozzles 115a-g in fluid communication with the flow path. Selectively controlling the water flow to the nozzles 115a-g may permit a showerhead 100 to operate in one or more modes. For example, certain flow paths be may selectively opened or closed to create a high pressure, a mist, or a pulsating water flow from the showerhead 100. The foregoing example is merely illustrative of some potential modes of operation for a showerhead. Accordingly, the nozzles and flow paths in a showerhead may be configured to create any suitable mode or modes of operation, including any of the aforementioned modes.

Each showerhead nozzle 115a-g may be configured to form a certain shaped flow stream when water exits the showerhead 100 through the showerhead nozzle 115a-g. For example, a showerhead nozzle may create a water stream with a circular, fan, cruciform, cone, partial cone, or other suitable shape. Further, two or more of the showerhead nozzles 115a-e may be configured so that their respective water streams 125a-e converge at a region 130 in space. For example, the exits for the showerhead nozzles 115a-e may be configured to deliver their respective streams 125a-e at a radial inwardly and downwardly sloping angle relative to the showerhead face 135 to cause the streams 125a-e to converge at a common region 130. As another example, the positions of the nozzles relative to each other and/or the sizes of the streams exiting the nozzles may be configured for the edge portions of adjacent streams to intersect at one or more regions. The foregoing examples are merely illustrative and other methods for converging at least portions of water streams exiting the showerhead 100 to a common region or regions may be used.

The shape and flow rate of the water streams 125a-e that converge at a region 130 in space may be designed such that when the streams 125a-e converge, multiple water droplets 140a-z are formed from the converging streams 125a-e. Prior to convergence, each converging stream 125a-e may generally resemble the shape formed by the nozzle 115a-e from which it exited as shown, for example, in FIG. 1B. Upon convergence, each converging stream 125a-e may generally cease to substantially resemble the shape formed by the nozzle 115a-e from which it exited since each water stream may be substantially dispersed into multiple, randomly distributed droplets 140a-z. In some embodiments, however, the convergence may cause a partial dispersion of the streams into multiple, randomly distributed water droplets while at least some portions of one or more of the converging streams may maintain at least a portion of their original stream shape and may continue to move along the original trajectory absent any interference with another stream. Thus, a converging water stream may flow out of a nozzle as a stream for a distance, then may at least partially contact at least one other stream to substantially break at least portions of these streams into droplets.

The two or more converging water streams may converge, partially or completely, at one or more regions prior to the water from the streams contacting the showerhead's user. Since shower users typically stand about 18 inches or so away from a showerhead when showering, each converging water stream may converge at one or more regions approximately 18 inches or closer from the showerhead. The maximum flow rate for a water stream to be partially or substantially broken into multiple droplets upon convergence with one or more other water streams may depend upon the shape of the water stream and the shape and flow rates of the other converging streams. Additionally, each water stream that converges with one or more other water streams may optionally have a shape and flow rate similar to the streams with which it is converging. Thus, nozzles 115a-e designed to cause their respective streams 125a-e to converge at least partially with other streams may be configured to form water streams 125a-e having similar shapes, as shown, for example, in FIG. 1B.

The showerhead 100 shown in FIGS. 1A and 1B may have five nozzles 115a-e configured to form five water streams 125a-e that converge at a region 130 in space approximately five inches in front of the showerhead. Although described as approximately five inches from the showerhead 100, the region 130 may be designed to be closer or further than five inches from the showerhead 100 if desired. Upon convergence, the five water streams 125a-e may substantially break into multiple water droplets 140a-z. Portions of each stream 125a-e, however, may continue on their original trajectory depending upon factors such as the speed of the stream, the relative portion of the stream contacting other streams, the shape of the stream, and so on. Thus, the five water streams 125a-e flow out of their respective nozzles 115a-e for about five inches and then contact each other, thereby causing at least portions of each water stream 125a-e, up to and including the whole water stream, to substantially break into multiple water droplets 140a-z.

Although five water streams 125a-e are shown as converging in FIGS. 1A and 1B, more or less water streams may be caused to converge at this region 130 or other regions. Further, two or more nozzles may be configured to cause two or more water streams to converge at two or more regions. For example, a showerhead may have four nozzles with two nozzles configured to have their respective water streams converge at a first region and the other two nozzles configured to have their respective water streams converge at a second region. Continuing with the example, these different groups of nozzles may operate in separate, distinct modes, or may operate in the same mode. As another example, a showerhead may have twelve nozzles with six nozzles configured to have their respective water streams converge at a first region, three other nozzles configured to have their respective water streams converge at a second region, and the remaining three nozzles configured to have their respective water streams converge at a third region. Again, each group of nozzles may operate in a separate mode or may operate concurrently with other groups of nozzles in the same mode. Thus, any number of showerhead nozzles may be configured to cause any number of water streams to converge at any number of regions in space, which may be selected to occur at any desired distance from the showerhead. Further, a group of nozzles delivering streams to a specific region may operate in a different mode or modes than other nozzles delivering streams to a different region, or may operate in the same mode or modes with these other nozzles.

Showerheads, if desired, may also include nozzles configured so that their water streams do not converge with water streams from other nozzles. Thus, some nozzles in a showerhead may be configured so that their water streams converge with water streams from other nozzles while other nozzles in the showerhead may be configured so that their water streams do not converge with water streams from other nozzles. In this way, converging and non-converging streams may be used on the same showerhead. Nozzles delivering converging and non-converging streams from the showerhead may function in the same mode or in separate modes. Thus, a showerhead may include modes in which each nozzle operating in the mode delivers a stream that converges with at least one other stream, modes in which each nozzle delivers a stream that does not converge with any other stream, and modes in which some nozzles deliver streams that converge with at least one other stream and other nozzles deliver streams that do not converge with any other stream.

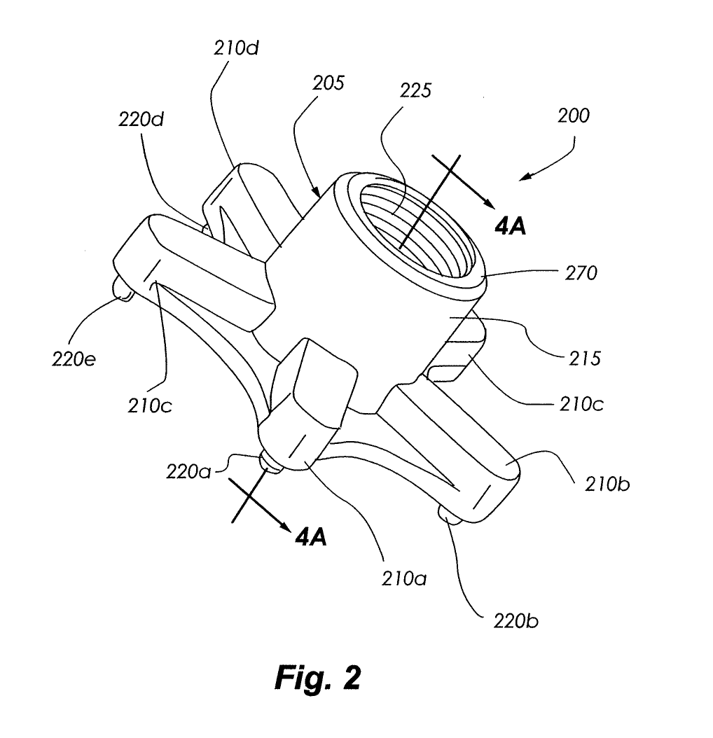

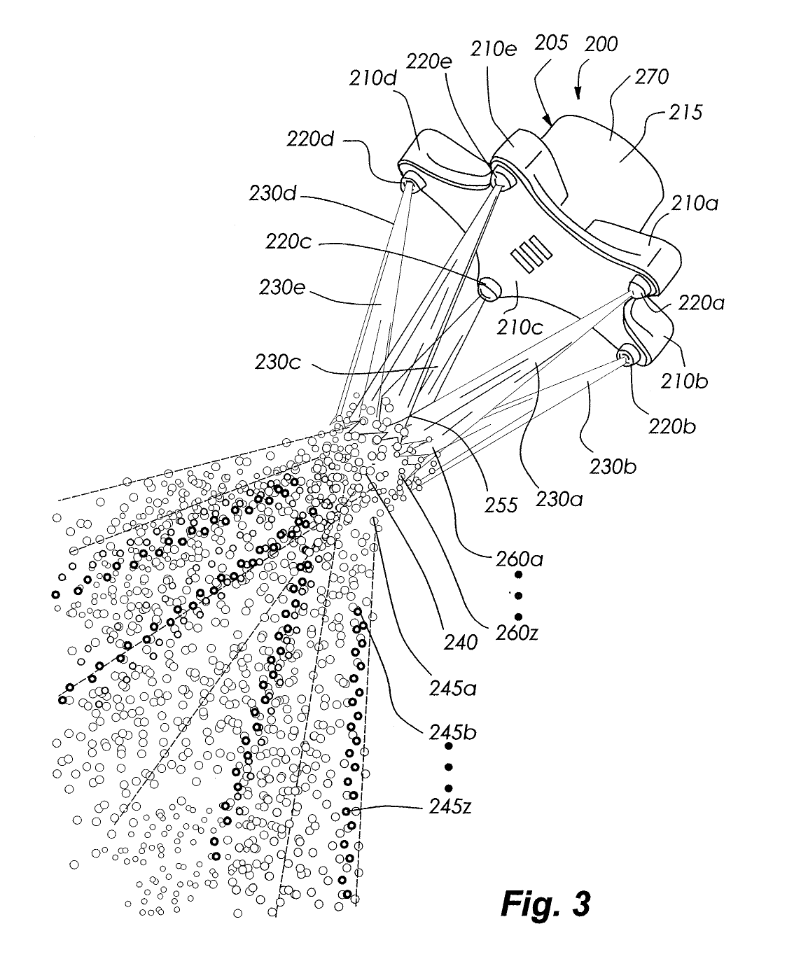

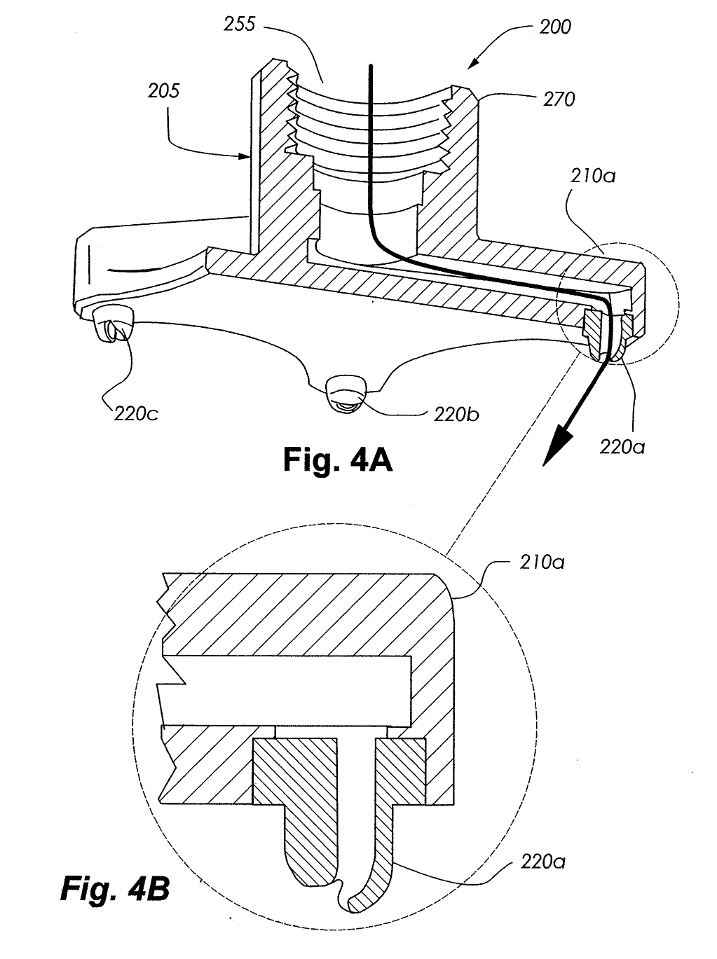

Two or more showerhead nozzles may also be configured so that portions of their respective streams converge with portions of other streams at two or more regions. FIGS. 2-4B depict a second example of a showerhead 200 where portions of streams converge with portions of other streams at two or more regions. The showerhead body 205 for the second showerhead example may resemble a five pointed star in front plan view with arms 210a-e extending radially outward from a central portion 215. Each arm 210a-e may include a nozzle 220a-e positioned near an end portion of the arm 210a-e distal the central portion 215 of the showerhead body 205. Water may flow into the showerhead 200 from a shower pipe though a water inlet 225. From the water inlet 225, water may then flow to each nozzle 220a-e via flow paths connecting each nozzle 220a-e to the water inlet 225.

Each nozzle 220a-e may be configured to form a fan shaped water stream 230a-e in which the main, inner portion of each water stream 230a-e converge at a first region 240 to cause the water streams 230a-e to disperse into multiple droplets 245a-z as described in more detail above with respect to the first showerhead example 100. Additionally, edge portions of one or more water streams 230a-e may converge with edge portions of adjacent water streams 230a-e at another region 255, or regions, thereby causing the edge portions of one or more water streams 230a-e to disperse into multiple water droplets 260a-z at this other region 255, or regions. Thus, the central portion of each stream 230a-e may converge at a first region 240, while the edge portions may converge one or more regions 255 closer to the showerhead 200.

The second showerhead 200 example, or any showerhead, including any described herein, may be directly or indirectly joined to a showerhead pipe. For example, the showerhead 200 may be directly joined to the showerhead pipe using a showerhead connection portion 270. The showerhead connection portion 270 may be formed proximate the water inlet 225 and may take the form of internal threads (see, e.g., FIGS. 2 and 4A) that mate with threads formed on the showerhead pipe. The showerhead 200 may be directly joined to the showerhead pipe by other suitable methods, including, but not limited to, press fitting, clamping, welding, adhering, any combination thereof (including using threaded connections), and so on. An O-ring (not shown) or other sealing element may be located within the water inlet 225 to form a water-tight seal between the showerhead 200 and the shower pipe.

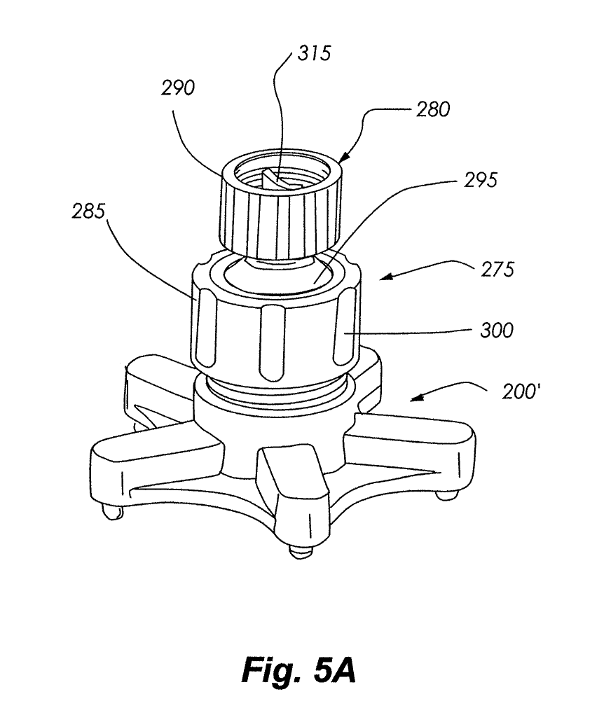

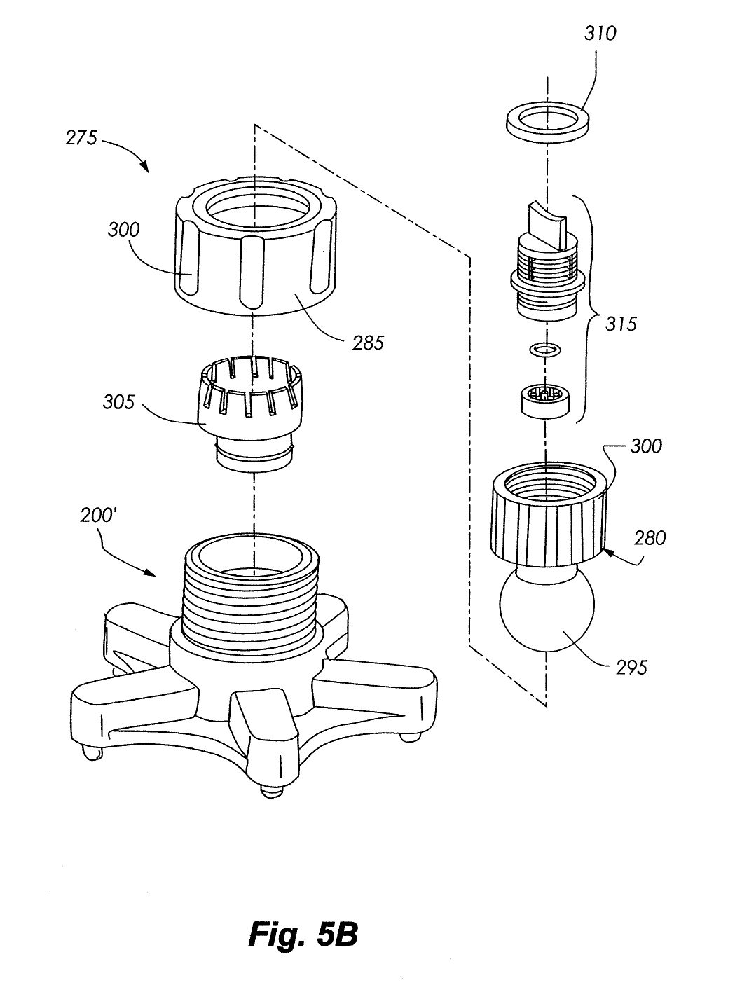

As yet another example, the showerhead 200′ may be indirectly joined to a showerhead pipe using a showerhead coupling assembly 275 or other suitable indirect connection method. With reference to FIGS. 5A and 5B, the showerhead coupling assembly 275 may include a ball joint member 280 movably joined to a coupling member 285, such as a coupling nut or the like. The ball joint member 280 may include a connection portion 290, such as a threaded end portion, for joining the ball joint member 280 to a showerhead pipe and a ball joint portion 295 for pivotally coupling the ball joint member 280 to the coupling member 285. The coupling member 285 may include a threaded portion for joining the coupling member 285 to the showerhead 200′, and grooves 300 formed on its outer surface for facilitating grasping by a user when joining and removing the coupling member 285 from the showerhead 200′. Like the direct connection described above, joining approaches other than, or in combination with, threading members together may be used to join the coupling member 285 to the showerhead 200′ and/or the ball joint member 280 to the showerhead pipe.

Still continuing with the example, the showerhead 200′, when joined to the showerhead pipe by the coupling assembly 275, may be pivoted relative to the showerhead pipe by pivoting the coupling member 285 relative to the ball joint member 280. Such pivotal movement allows a user to change to the direction the showerhead nozzles face relative to the showerhead pipe. With continued reference to FIGS. 5A and 5B, the showerhead coupling assembly 275 may further include a cup seal 305, or other suitable seal, to prevent water from flowing outside of the showerhead 200′ along the joint formed between the showerhead coupling member 285 and the showerhead 200′. An O-ring 310, or other suitable seal, may be placed between the showerhead ball joint member 280 and the showerhead pipe to prevent water from flowing through the joint formed between the showerhead ball joint member 280 and the showerhead pipe. If desired, a flow restrictor 315 may be positioned within the showerhead ball joint member 280 between the showerhead pipe and the showerhead ball joint member 280 to restrict the amount of flow received by the showerhead 200′ from the showerhead pipe and/or to increase the pressure of the water exiting the showerhead 200′.

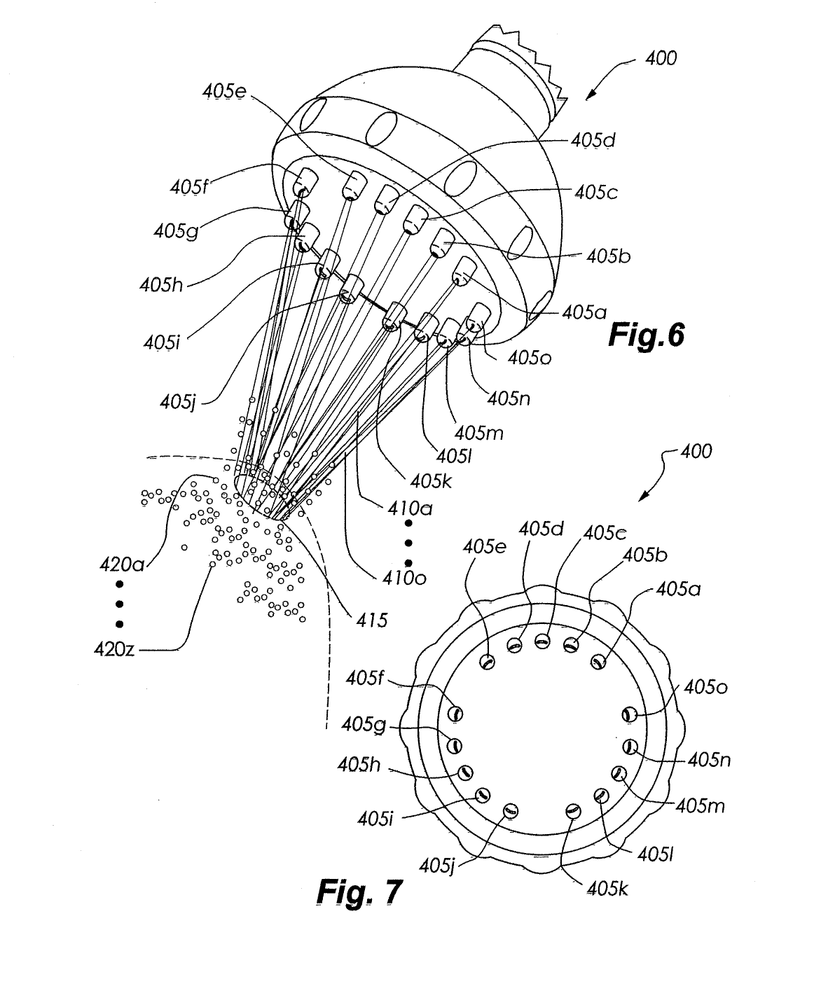

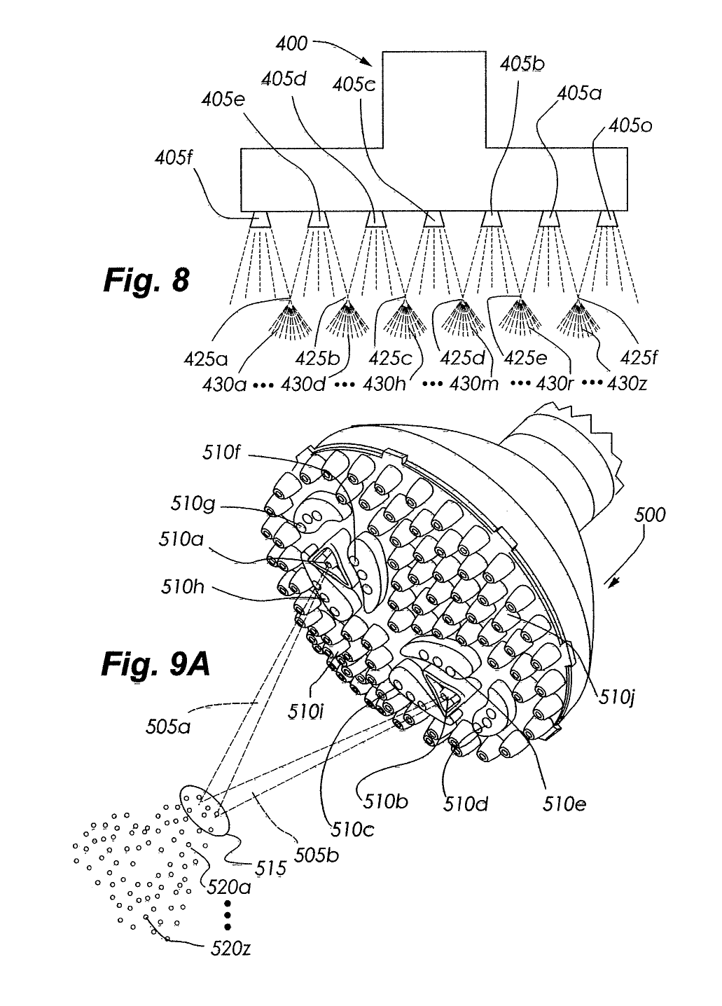

FIGS. 6-8 depict various views of a third example of a showerhead 400, which may have fifteen nozzles 405a-o arranged around the perimeter of the showerhead 400 in three groups of five nozzles. Similar to the second showerhead 200 example, each nozzle 405a-o may be configured to form a fan shaped water stream in which the main, inner portion of each water stream 410a-o converge at a first region 415 to cause the water streams 410a-o to disperse into multiple droplets 420a-z as described in more detail above with respect to the first showerhead 100 example. Similar to the water streams for the second showerhead 200 example, edge portions of one or more water streams 410a-o may converge with edge portions of adjacent water streams 410a-0 at second regions 425a-f, thereby causing the edge portions of the water streams 410a-o to disperse into multiple water droplets 430a-z at these second regions 425a-f.

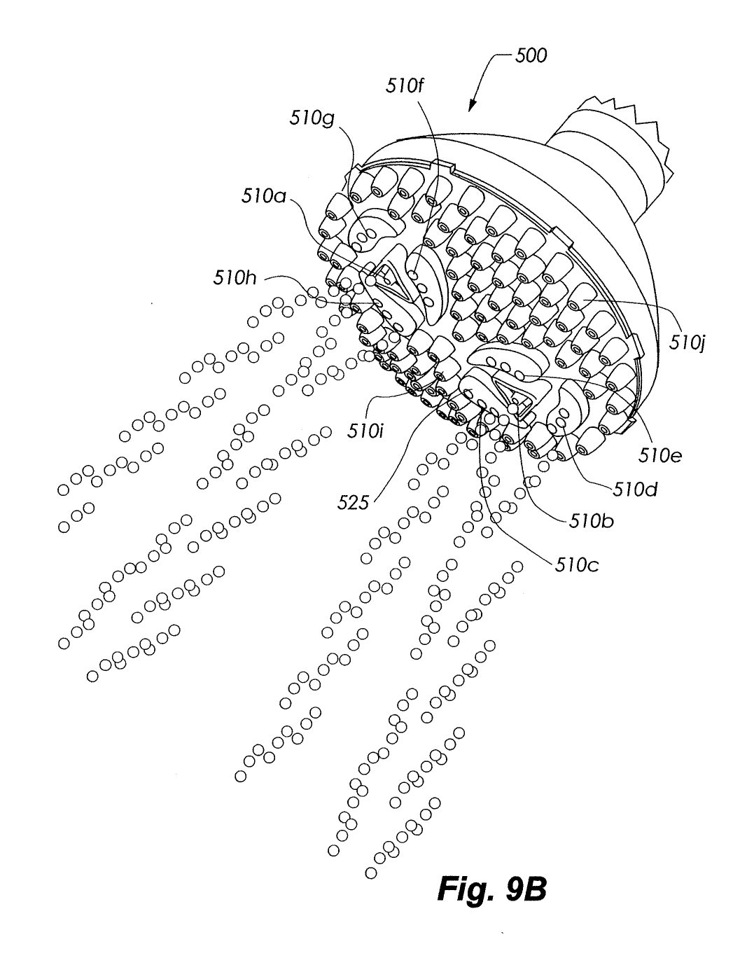

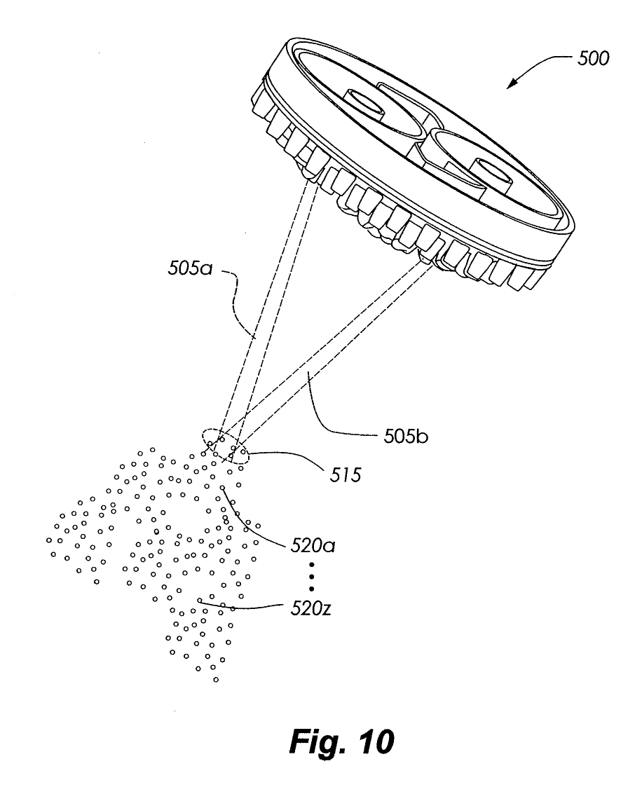

FIGS. 9A, 9B and 10 depict various views of a fourth example of a showerhead 500, which may include two diametrically opposed nozzles 510a-b. These two nozzles may be further configured so that their respective streams 505a-b converge at one or more regions 515 to form multiple droplets 520a-z in a manner similar to the one described above with respect to the previous showerhead examples. Water to these nozzles 510a-b, or to other nozzles 510c-j, may be supplied from fluid chambers formed in, or defined by, the showerhead body. These fluid chambers, in turn, may be in fluid communication with a water inlet for the showerhead 500.

The fourth showerhead 500 example may have other nozzles 510c-j for delivering water from the showerhead 500 in other modes such a high pressure mode, a pulsating mode, a mist mode, and so on. FIG. 9B, for example, shows the showerhead 500 operating in a pulsating mode with water delivered from the showerhead 500 through the nozzles (or openings) 510c-h formed in the tear-drop shaped structures 525. Any of these other nozzles 510c-h may also be configured, if desired, to cause their respective water streams to converge with other streams. As an example, pulsating streams, which pulsate synchronously, may be caused to converge to substantially break the converging, pulsating streams into water droplets. Additionally, the showerhead 500, or any showerhead with multiple modes, may be configured to deliver water concurrently in more than one mode, including at least one mode in which the water streams converge.

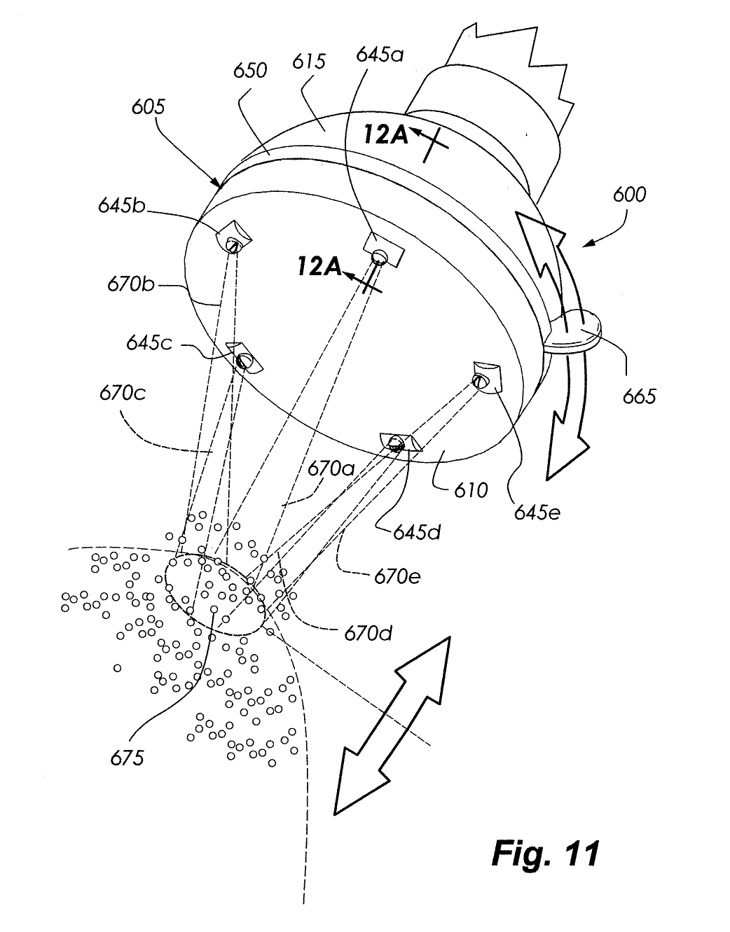

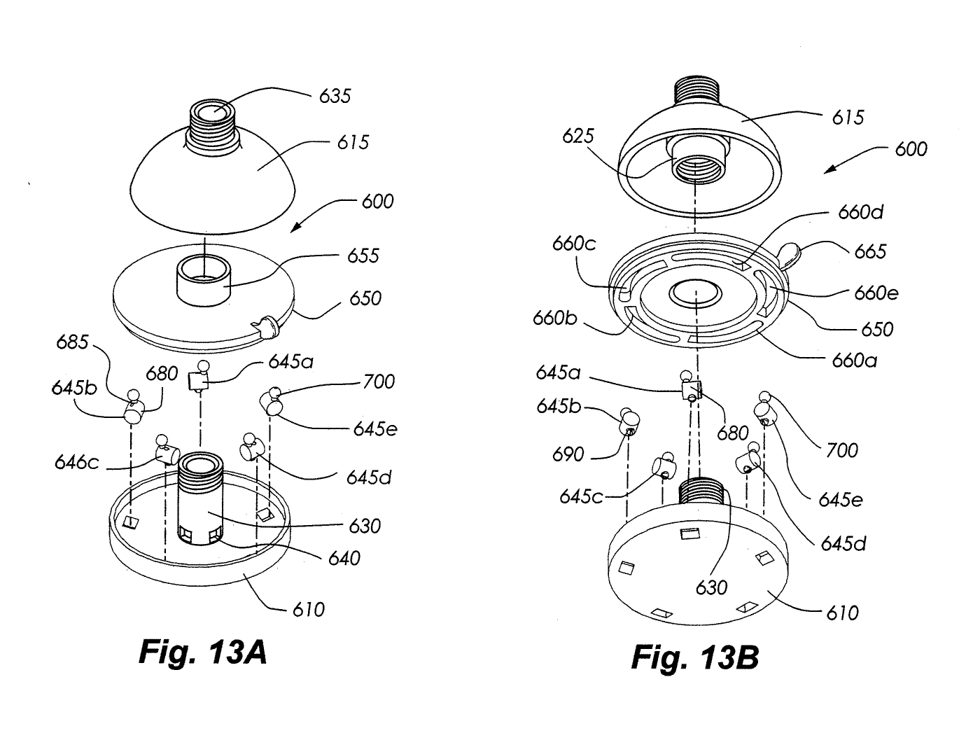

For any of the above described showerheads or any other showerhead with converging streams, the nozzles, or components joining the nozzles to the showerhead, may be selectively movable to selectively move the region or regions closer to or further away from the showerhead, or to selectively convert the nozzles from delivering converging to non-converging streams (or vice versa). FIGS. 11-13B depict a fifth example of a showerhead 600 showing one possible mechanism for such selective movement.

The fifth showerhead 600 example may include a showerhead body 605 formed from a showerhead face 610 and showerhead upper portion 615. The showerhead face 610 and a cam 650 may define a showerhead chamber 620 for receiving water from a shower pipe or the like joined to the showerhead upper portion 615 by a threaded connection, any connection method described herein for any other showerhead, or any other suitable joining method. The showerhead face 610 and showerhead upper portion 615 may each include fluid passage shafts 625, 630, which may be threaded together or otherwise suitably joined, to connect the showerhead face 610 to the showerhead upper portion 615 and to define a fluid passage between the showerhead fluid inlet 635 and the showerhead chamber 620. Fluid outlets 640 defined in the showerhead face's fluid passage shaft 630 may provide fluid communication between the fluid passage and the showerhead chamber 620. Other methods, such as tubes, channels, and so on, may be used to deliver fluid from the fluid inlet 635 to the showerhead fluid chamber and/or the shower nozzles 645a-e.

A cam 650 or other structure may be positioned between the showerhead upper portion 615 and showerhead face 610. The cam 650 may include a hub portion 655 for receipt on the showerhead upper portion's fluid passage shaft 625. The cam 650 may be rotated relative to the showerhead upper portion 615 and the showerhead face 610 around the showerhead upper portion's fluid passage shaft 625. The cam 650 may define one or more cam slots 660a-e for engaging nozzles 645a-e pivotally joined to the showerhead face 610. Movement of the cam 650, for example, by rotating the cam 650 using a hand grip 665 or other structure, may pivot the nozzles 645a-e relative to the showerhead 600 to adjust the angle the water streams 670a-e exit the nozzles 645a-e relative to the showerhead 600.

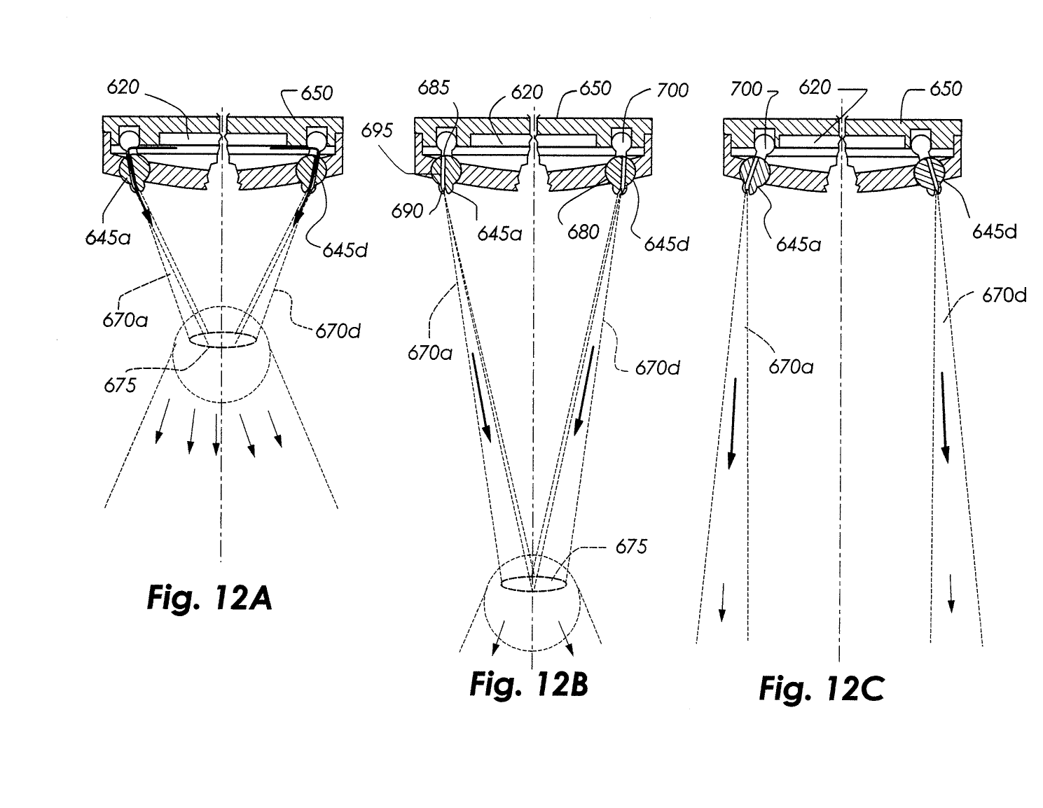

With reference to FIGS. 12A-C, increasing the angle (as measured between the showerhead face 610 and a water stream 670a-e) moves the region 675 or regions of convergence further from the showerhead 600 (see, e.g., FIG. 12B), while decreasing the angle moves the region 675 or regions of convergence closer to the showerhead 600 (see, e.g., FIG. 12A). If desired, the nozzles 645a-e may be configured for selective conversion to and from delivering converging and non-converging streams. For example, the cam 650 and nozzles 645a-e may be configured such that the cam 650 may pivot the nozzles 645a-e relative to the showerhead 600 to a position where the streams 670a-e from one or more nozzles 645a-e that previously converged exit parallel or divergent to each other (see, e.g., FIG. 12C).

Each nozzle 645a-e may include a nozzle body portion 680 pivotally joined to the showerhead face 610 and defining a fluid inlet 685, a fluid outlet 690, and fluid passage 695 fluidly joining the fluid inlet 685 to the fluid outlet 690. Each nozzle 645a-e may further include a nozzle ball portion 700 for engagement with a cam slot 660a-e formed in the cam 650. The radial distance of each cam slot 660a-e from the center of the cam 650 may change along the length of the cam slot 660a-e, thus causing the nozzle 645a-e to pivot relative to the showerhead face 610 through engagement of the cam slot 660a-e with the nozzle ball portion 700. More particularly, as the radial distance of the cam slot 660a-e adjacent the nozzle ball portion 700 either increases or decreases by rotating the cam 650 relative to the showerhead face 610, the nozzle ball portion 700 moves away or towards the radial center of the showerhead face 610, thus causing the stream exiting the nozzle to rotate towards or away from the showerhead face 610 (i.e., decrease the relative angle or increase the relative angle.)

Although not shown, O-rings, cup seals, and so on may be used to seal the connections between the various components of the fifth showerhead 600 example, including connections between any of the showerhead upper portion 615, the showerhead face 610, the cam 650, and the nozzles 645a-e. Yet further, other types of cams or methods of pivoting or otherwise moving the nozzles relative to the showerhead may be used, if desired.

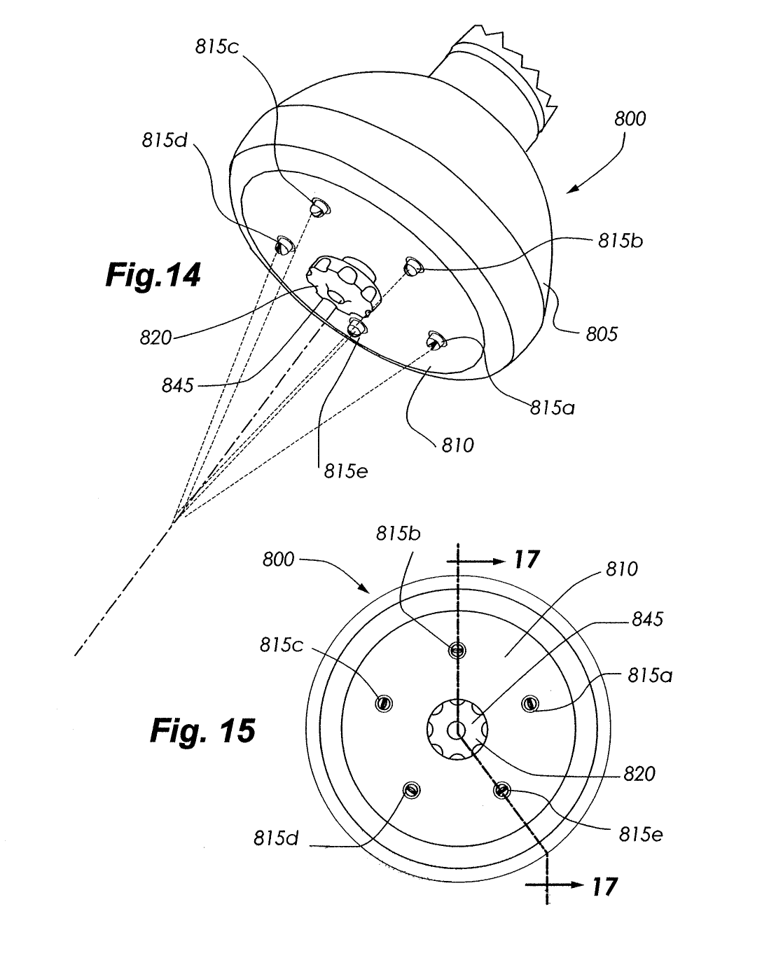

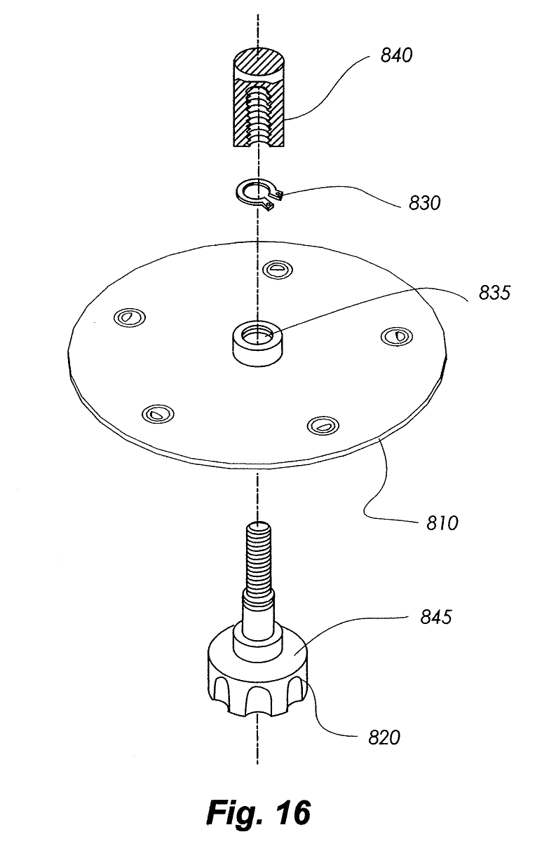

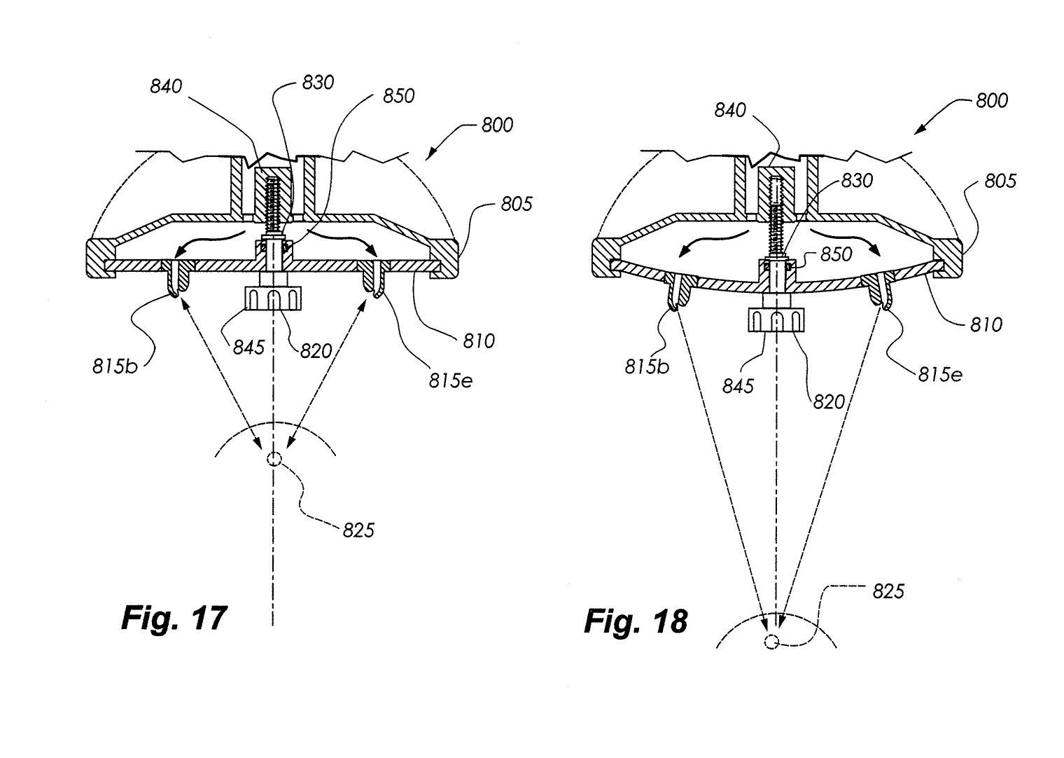

FIGS. 14-18 depict a sixth example of a showerhead 800 depicting yet another possible mechanism for changing the region of convergence. The showerhead 800 may include a showerhead body 805 joined to a flexible showerhead face plate 810. The showerhead face plate 810 may be formed from flexible rubber, flexible plastic, light-gauge metal, or other flexible material. An O-ring, cup seal, or other suitable sealing element or system may be positioned between the joint formed between the showerhead face plate 810 and the showerhead body 805 to prevent fluid leakage between these two components. Nozzles 815a-e may be joined to the showerhead face plate 810. The showerhead face plate 810 may be converted from a planar to an outwardly or convexly curved profile using a threaded screw 820 or other mechanical system, as shown, for example, in FIGS. 17 and 18. As the showerhead face plate 810 moves from a planar to a convex profile, the region 825 or regions of convergence moves further from the showerhead face plate 810. Similar to the mechanism described above, the nozzles 815a-e may be configured to convert from generating converging to non-converging streams as the showerhead face place 810 moves from a planar to a curved profile.

The mechanical system for moving the showerhead face plate 810 from a planar to a curved profile may include the threaded screw 820, or other suitable fastener, joined to the showerhead face plate 810 using a clip 830 or other joining element. The threaded screw 820 may be received through a fastening hole 835 or aperture defined in the showerhead face plate 810. The clip 830 may then be joined to the threaded screw 820 to maintain a joined relationship between the threaded screw 820 and the showerhead face plate 810. The threaded screw 820 may be received in a fastener shaft 840 formed in, or joined to, the showerhead body 805. Tightening the threaded screw 820 into the fastener shaft 840 moves the showerhead face plate 810 from a curved towards a planar profile, while loosening the threaded screw 820 moves the showerhead face plate 810 from a planar towards a curved profile. The threaded screw 820 may include a knob 845 for a user to grasp to facilitate tightening and loosening the threaded screw 820. An O-ring 850 or other suitable seal element may be positioned between the threaded screw 820 and the showerhead face plate 810 to prevent fluid leakage between these two elements. The above described mechanical system is merely illustrative of one possible mechanism for moving the showerhead face plate 810 from a planar to a curved profile, and vice versa, and is not intended to limit other potential systems, devices, or methods for achieving similar results.

The foregoing examples are merely illustrative of some mechanisms for changing the region or regions of convergence of the streams, or for converting the nozzles from delivering converging streams to delivering non-converging streams, and are not intended to limit other potential approaches to change the regions of convergence, or convert the nozzles from delivering converging to delivering non-converging streams (or vice versa).

In combination with, or in lieu of, causing water streams to converge to disperse into multiple droplets, other methods may be used to break water streams from showerheads into multiple droplets. For example, a showerhead may have a nozzle that delivers a rotating water stream with a sufficient angular velocity to break the stream into multiple droplets. As another example, one or more showerhead nozzles may be configured to deliver one or more water streams that impact a structure external to the showerhead (e.g., a plate), which causes the water streams to break into multiple droplets. As yet another example, one or more showerhead nozzles may be configured to deliver one or more water streams through a structure external to the showerhead (e.g., a screen), which causes the water streams to break into multiple droplets. Either of the structures (e.g., the plate or the screen) may or may not be connected to the showerhead.

Any of the various showerheads or showerhead components described herein may be composed of plastic, metal, any other suitable material, or some combination thereof. Any of showerhead components may be joined or connected to other components by any suitable method, including, but not limited to, sonic or heat welding, mechanical fastening, adhering or gluing, and so on, and/or may be integrally formed with other components. Yet further, any of the showerhead components may be formed integrally, or may be formed from multiple pieces joined or otherwise connected by any suitable methods.

Showerheads with alternate configurations for the showerhead body, and/or for the number and arrangement of showerhead nozzles, other than those described herein may be used to deliver at least one water stream from the showerhead that at least partially breaks into multiple droplets prior to contact with a person taking a shower. For example, a showerhead may have multiple nozzles configured to deliver water streams that converge only with the water stream of an adjacent nozzle. As another example, the showerhead body may be generally conical as depicted in FIGS. 1A, 6, and 9A, generally star shaped as depicted in FIGS. 2 and 5A or any other suitable shape. Accordingly the matter contained in the above description or shown in the accompanying drawings shall be interpreted as illustrative only and not limiting.

All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the present invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Changes in detail or structure may be made without departing from the spirit of the invention as defined in the appended claims.

What is claimed is:

1. A showerhead comprising:
a water inlet; and
a plurality of nozzles in fluid communication with the water inlet and at least two of the plurality of nozzles configured such that water streams exiting the at least two of the plurality of nozzles converge at least at one region to substantially convert at least portions of the water streams into multiple water droplets.

2. The showerhead of claim 1, wherein each region occurs approximately eighteen inches or less from the showerhead.

3. The showerhead of claim 1, wherein water streams having a common convergence region have a substantially similar shape.

4. The showerhead of claim 3, wherein the shape is selected from the group consisting of a fan, flat, conical, partially conical, helical, or cruciform shaped water stream.

5. The showerhead of claim 1, wherein water streams having a common convergence region have a substantially similar flow rate.

6. The showerhead of claim 1, further comprising a body defining at least one flow path for fluidly joining the water inlet to at least one of the plurality of nozzles.

7. The showerhead of claim 1, further comprising a showerhead coupling assembly selectively operatively associated with the water inlet.

8. The showerhead of claim 7, wherein the showerhead coupling assembly comprises a ball joint member pivotally connected to a coupling member.

9. The showerhead of claim 8, wherein selectively operatively associating the showerhead coupling assembly with the water inlet comprises selectively joining the coupling member to the water inlet.

10. The showerhead of claim 1, further comprising a threaded portion proximate the water inlet.

11. The showerhead of claim 1, wherein the showerhead includes at least two modes of operation.

12. The showerhead of claim 11, wherein at least one of the two modes of operation comprises delivering water streams from the at least two of the plurality of nozzles.

13. The showerhead of claim 12, wherein at least one other of the two modes of operation comprises delivering a pulsating stream from the plurality of nozzles.

14. The showerhead of claim 1, wherein the at least two of the plurality of nozzles includes at least five nozzles configured such that water streams existing the at least five nozzles converge at a common region to substantially convert at least portions of the water streams from the at least five nozzles into multiple water droplets.

15. The showerhead of claim 1, wherein at least one of the at least one region is selectively movable relative to the showerhead.

16. The showerhead of claim 1, wherein at least one of the at least two nozzles is selectively movable such that its water stream does not converge with the water streams of the other of the at least two nozzles.

17. The showerhead of claim 15, wherein moving the at least one selectively movable region comprises pivoting the at least two nozzles relative to a showerhead face.

18. The showerhead of claim 15, further comprising a flexible face plate selectively movable from at least a first position to a second position, the at least two nozzles joined to the flexible face plate, wherein moving the at least one selectively movable region comprises moving the showerhead plate from a first position to a second position.
